(19) United States
(12) Patent Application Publication
(10) Pub. No.: US 2026/0267279 A1
(43) Pub. Date: Sep. 10, 2026

(54) IMAGE FORMING APPARATUS AND DEVELOPER CONTAINER

(71) Applicants: Ryoma Ikemoto, Kanagawa (JP); Manabu Fujisaki, Kanagawa (JP); Kazuhiro Ikeda, Chiba (JP); Atsushi Okada, Kanagawa (JP)

(72) Inventors: Ryoma Ikemoto, Kanagawa (JP); Manabu Fujisaki, Kanagawa (JP); Kazuhiro Ikeda, Chiba (JP); Atsushi Okada, Kanagawa (JP)

(73) Assignee: ETRIA Co., Ltd., Kanagawa (JP)

(21) Appl. No.: 19/458,722

(22) Filed: Jan. 24, 2026

(30) Foreign Application Priority Data
Mar. 7, 2025 (JP) 2025-035975

(51) Int. Cl. G03G 21/16; G03G 15/00; G03G 15/08

(52) U.S. Cl. CPC G03G 21/1652; G03G 15/0863; G03G 15/0865; G03G 15/55; G03G 15/80; G03G 21/1647; G03G 2221/1654

(57) ABSTRACT

An image forming apparatus includes: an image forming apparatus body; a developer container detachably attached to the body and including a securing unit secured to the body, a rotator relatively rotatable with respect to the securing unit, and a container-side electrode unit provided with the securing unit; an image forming device to form an image with a developer that is discharged from a developer discharge port of the securing unit by rotation of the rotator in a normal direction; a body-side electrode unit to contact the container-side electrode unit of the developer container attached to the body; and a position change structure to change a relative position between the container-side electrode unit and the body-side electrode unit of the developer container attached to the body. The position change structure changes the relative position with rotation of the rotator in a reverse direction opposite to the normal direction.

### CROSS-REFERENCE TO RELATED APPLICATION

This patent application is based on and claims priority pursuant to 35 U.S.C. § 119(a) to Japanese Patent Application No. 2025-035975, filed on Mar. 7, 2025, in the Japan Patent Office, the entire disclosure of which is hereby incorporated by reference herein.

### BACKGROUND

### Technical Field

The present disclosure relates to image forming apparatuses and developer containers.

### Related Art

An image forming apparatus has been proposed that uses a developer container detachably attached to an image forming apparatus body and has a securing unit secured to the image forming apparatus body and a rotator rotatable relative to the securing unit.

### SUMMARY

The present disclosure described herein provides an image forming apparatus that includes an image forming apparatus body, a developer container, an image forming device, a body-side electrode unit, and a position change structure. The developer container is detachably attached to the image forming apparatus body. The developer container includes a securing unit, a rotator, and a container-side electrode unit. The securing unit is secured to the image forming apparatus body. The rotator is relatively rotatable with respect to the securing unit. The container-side electrode unit is provided with the securing unit. The image forming device forms an image with a developer that is discharged from a developer discharge port of the securing unit by rotation of the rotator in a normal direction. The body-side electrode unit contacts the container-side electrode unit of the developer container attached to the image forming apparatus body. The position change structure changes a relative position between the container-side electrode unit and the body-side electrode unit of the developer container attached to the image forming apparatus body, with rotation of the rotator in a reverse direction opposite to the normal direction.

The present disclosure described herein also provides a developer container detachably attachable to an image forming apparatus body. The developer container includes a securing unit, a rotator, a container-side electrode unit, and a position change structure. The securing unit is secured to the image forming apparatus body. The rotator is relatively rotatable with respect to the securing unit. The securing unit has a developer discharge port from which a developer is discharged by rotation of the rotator in a normal direction. The container-side electrode unit is provided with the securing unit, to contact a body-side electrode unit of the image forming apparatus body when the developer container is attached to the image forming apparatus body. The position change structure changes a relative position between the container-side electrode unit and the body-side electrode unit, when the rotator is rotated in a reverse direction opposite to the normal direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of a copier according to an embodiment;

FIG. 2 is a schematic diagram illustrating an image formation unit of the copier;

FIG. 3 is a schematic diagram illustrating a state in which a toner container is installed in a toner supply device in the copier;

FIG. 4 is a schematic perspective view illustrating a state in which a toner container is installed in a toner container housing of the copier;

FIG. 5 is a perspective explanatory view of a toner container;

FIG. 6 is a perspective explanatory view of the toner supply device and the toner container before the toner container is attached;

FIG. 7 is a perspective explanatory view of the toner supply device and the toner container in a state where the toner container is attached;

FIG. 8 is a cross-sectional explanatory view of the toner supply device and the toner container before the toner container is attached;

FIG. 9 is a perspective explanatory view of the toner container in a state in which the nozzle receiver is removed from the container body;

FIG. 10 is a cross-sectional explanatory view of the toner container in a state where the nozzle receiver is removed from the container body;

FIG. 11 is a cross-sectional explanatory view of the toner container in a state in which the nozzle receiver is attached to the container body from the state of FIG. 10;

FIG. 12 is an explanatory view for explaining an internal structure of a toner supply device and a toner container;

FIG. 13 is a perspective explanatory view of a connector secured to the toner supply device and a container front end of the toner container;

FIG. 14 is a three-view diagram of an identification (ID) tag, in which FIG. 14A is a front view, FIG. 14B is a side view, and FIG. 14C is a back surface view;

FIGS. 15A and 15B are circuit diagrams each illustrating an electric circuit of an ID tag and an electric circuit of a connector;

FIG. 16A is an explanatory view schematically illustrating an ID-tag holding mechanism when the container body of the toner container is rotated in the normal direction in the embodiment;

FIG. 16B is an explanatory view schematically illustrating the holding mechanism when the container body of the toner container is rotated in a reverse direction opposite to the normal direction;

FIG. 17 is an enlarged view illustrating a configuration of the holding mechanism when the container body of the toner container is rotated in the reverse direction opposite to the normal direction;

FIG. 18 is an explanatory diagram illustrating an example in which a contact direction in which a grounding body-side terminal and a communication body-side terminal of a connector are in contact with a ground terminal and a metal pad of an ID tag is a direction along a horizontal direction;

FIG. 19 is an explanatory view illustrating a modification in which a movable claw in the holding mechanism is operated; and

FIG. 20 is a flowchart illustrating an example of a contact recovery operation between the ground terminal and the metal pad of the ID tag on the toner container side and the grounding body-side terminal and the communication body-side terminal of the connector on the image forming apparatus body.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An embodiment of the present disclosure will be described with an example of a copier (referred to as copier 500) serving as an image forming apparatus.

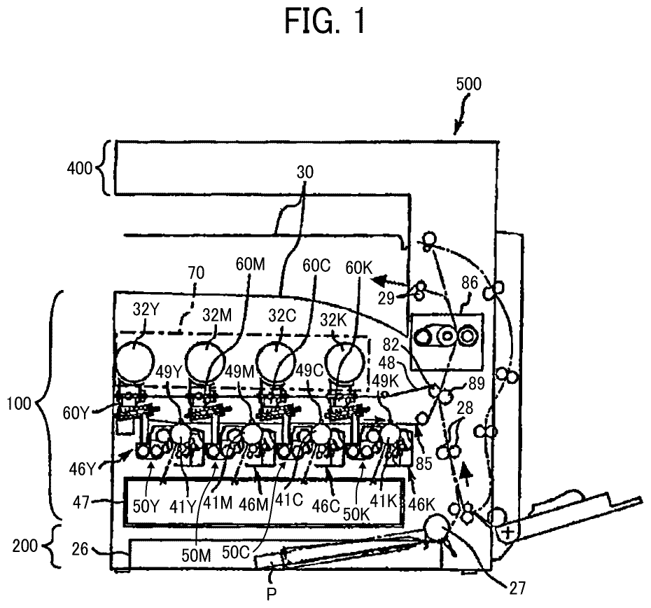

FIG. 1 is a schematic configuration diagram of a copier 500 according to the present embodiment.

The copier 500 according to the present embodiment includes a copier apparatus body (referred to as printer unit 100), a sheet feeding table (referred to as sheet feeder 200), and a scanner (referred to as a scanner unit 400) mounted on the printer unit 100.

Toner containers 32Y, 32M, 32C, and 32K as four developer containers corresponding to respective colors (Yellow, Magenta, Cyan, Black) are detachably (exchangeably) installed in the toner container housing 70 in an upper portion of the printer unit 100. An intermediate transfer unit 85 is disposed below the toner container housing 70.

The intermediate transfer unit 85 includes an intermediate transfer belt 48, four primary transfer bias rollers 49Y, 49M, 49C, and 49K, a secondary transfer backup roller 82, a plurality of tension rollers, and an intermediate transfer cleaning device. The intermediate transfer belt 48 is stretched and supported by a plurality of roller members, and endlessly moves in an arrow direction in FIG. 1 by rotational driving of a secondary transfer backup roller 82 which is one of the plurality of roller members.

The printer unit 100 has four image formation units 46Y, 46M, 46C, and 46K corresponding to the respective colors, which may be collectively referred to as image forming unit(s) 46, in parallel so as to face the intermediate transfer belt 48. The four toner supply devices 60Y, 60M, 60C, and 60K are disposed below four toner containers 32Y, 32M, 32C, and 32K, respectively. Then, the toners (developers) stored in the toner containers 32Y, 32M, 32C, and 32K are supplied (replenished) into developing devices 50Y, 50M, 50C, and 50K, which may be collectively referred to as developing device(s) 50, of the image formation units 46Y, 46M, 46C, and 46K corresponding to the respective colors by the corresponding toner supply devices 60Y, 60M, 60C, and 60K.

In addition, as illustrated in FIG. 1, the printer unit 100 includes an exposure device 47 as a latent image former below the four image formation units 46Y, 46M, 46C, and 46K. The exposure device 47 performs exposure on the surfaces of photoconductors 41Y, 41M, 41C, and 41K to be described later on the basis of image information of a document image read by the scanner unit 400 or image information input from an external device such as a personal computer, to form electrostatic latent images on the surfaces of the photoconductors. The exposure device 47 included in the printer unit 100 uses a laser beam scanner system using a laser diode, but may have another configuration using a light emitting diode (LED) array as an exposure module.

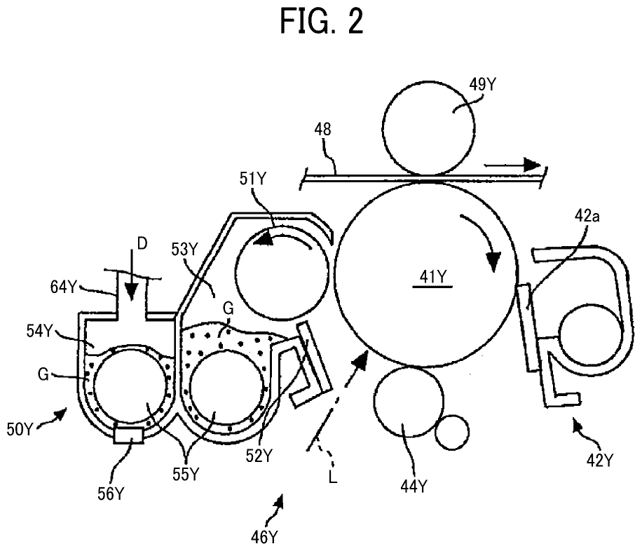

FIG. 2 is a schematic diagram illustrating a schematic configuration of an image formation unit 46Y corresponding to yellow.

The image formation unit 46Y includes a drum-shaped photoconductor 41Y as a latent image bearer. Furthermore, the image formation unit 46Y has a configuration in which, for example, a charging roller 44Y as a charging module, a developing device 50Y as a developing module, a photoconductor cleaning device 42Y, and a discharger are disposed around the photoconductor 41Y. Then, processes of image formation (charging process, exposure process, developing process, transfer process, and cleaning process) are performed on the photoconductor 41Y, and a yellow image is formed on the photoconductor 41Y.

The other three image formation units 46M, 46C, and 46K also have substantially the same configuration as the image formation unit 46Y corresponding to yellow except that the color of the toner to be used is different, and an image of a color corresponding to each toner is formed on each of the photoconductors 41M, 41C, and 41K. Hereinafter, description of the other three image formation units 46M, 46C, and 46K will be appropriately omitted, and only the image formation unit 46Y corresponding to yellow will be described.

The photoconductor 41Y is rotationally driven clockwise in FIG. 2 by a drive motor. Then, the surface of the photoconductor 41Y is uniformly charged at a position facing the charging roller 44Y (charging process). When the surface of the photoconductor 41Y reaches a position irradiated with a laser beam L emitted from the exposure device 47, the photoconductor 41Y is scanned with the laser beam L, and thus an electrostatic latent image for yellow is formed thereon (exposure process). Thereafter, the surface of the photoconductor 41Y reaches a position opposed to the developing device 50Y, and the electrostatic latent image is developed at this position to form a yellow toner image (developing process).

The four primary transfer bias rollers 49Y, 49M, 49C, and 49K in the intermediate transfer unit 85 form primary transfer nips by sandwiching the intermediate transfer belt 48 between the photoconductors 41Y, 41M, 41C, and 41K, respectively. Then, a transfer bias opposite to the polarity of the toner is applied to the primary transfer bias rollers 49Y, 49M, 49C, and 49K.

When the surface of the photoconductor 41Y on which the toner image has been formed in the developing process reaches the position facing the primary transfer bias roller 49Y via the intermediate transfer belt 48, the toner image is transferred from the photoconductor 41Y onto the intermediate transfer belt 48 in the primary transfer nip (primary transfer process). After the primary transfer process, a slight amount of toner is likely to remain untransferred on the photoconductor 41Y. After the toner image is transferred onto the intermediate transfer belt 48 at the primary transfer nip, the surface of the photoconductor 41Y reaches a position opposed to the photoconductor cleaning device 42Y. The untransferred toner remaining on the photoconductor 41Y at the position opposed to the photoconductor cleaning device 42Y is mechanically recovered by the cleaning blade 42a (cleaning process). Finally, the surface of the photoconductor 41Y reaches a position opposed to the discharger, at which the residual potential on the photoconductors 41Y is removed. In this way, a series of the processes of the image formation performed on the photoconductor 41Y is completed.

Such processes of image formation are performed in the other image formation units 46M, 46C, and 46K similarly to the yellow image formation unit 46Y. That is, the laser light L based on the image information is emitted from the exposure device 47 disposed below the image formation units 46M, 46C, and 46K toward the photoconductors 41M, 41C, and 41K of the image formation units 46M, 46C, and 46K. Specifically, the exposure device 47 emits a laser beam L from a light source, and irradiates the photoconductors 41M, 41C, and 41K with the laser beam L via a plurality of optical elements while scanning the laser beam L with a rotationally driven polygon mirror. Thereafter, the toner images of the respective colors formed on the photoconductors 41M, 41C, and 41K through the developing process are transferred onto the intermediate transfer belt 48.

At this time, the intermediate transfer belt 48 travels in the arrow direction in FIG. 1, and sequentially passes through the primary transfer nips of the primary transfer bias rollers 49Y, 49M, 49C, and 49K. As a result, the toner images of the respective colors on the photoconductors 41Y, 41M, 41C, and 41K are primarily transferred onto the intermediate transfer belt 48 in an overlapping manner, and a color toner image is formed on the intermediate transfer belt 48.

The intermediate transfer belt 48 bearing the multicolor toner image reaches a position opposed to a secondary transfer roller 89 opposed to the secondary-transfer backup roller 82. At this position, the secondary-transfer backup roller 82 and the secondary transfer roller 89 nip the intermediate transfer belt 48 therebetween to form a secondary transfer nip. Then, the color toner image formed on the intermediate transfer belt 48 is transferred onto the recording medium P such as a transfer sheet conveyed to the position of the secondary transfer nip. At this time, untransferred toner that has not been transferred to the recording medium P remains on the intermediate transfer belt 48. The intermediate transfer belt 48 having passed through the secondary transfer nip reaches a position of an intermediate transfer cleaning device, and untransferred toner on the surface of the intermediate transfer belt 48 is collected, and thus, a series of transfer processes performed on the intermediate transfer belt 48 ends.

The recording medium P conveyed to the secondary transfer nip is conveyed from a sheet feeding tray 26 of a sheet feeder 200 disposed below the printer unit 100 via, e.g., a sheet feeding roller 27 and a pair of registration rollers 28. Specifically, a plurality of recording media P is stacked and stored in the sheet feeding tray 26. Then, when the sheet feeding roller 27 is rotationally driven counterclockwise in FIG. 1, the uppermost recording medium P is conveyed toward the roller nip formed by the two rollers of the pair of registration rollers 28.

The pair of registration rollers 28 stops rotating temporarily, stopping the recording medium P with a leading edge of the recording medium P nipped in the roller nip between the pair of registration rollers 28. Then, in accordance with the timing at which the color toner image on the intermediate transfer belt 48 reaches the secondary transfer nip, the pair of registration rollers 28 is rotationally driven, and the recording medium P is conveyed toward the secondary transfer nip. Thus, the multicolor toner image is transferred onto the recording medium P.

The recording medium P onto which the color toner image has been transferred at the secondary transfer nip is conveyed to a position of a fixing device 86. In the fixing device 86, the color toner image transferred to the surface of the recording medium P is fixed onto the recording medium P by heat and pressure from a fixing belt and a pressure roller. The recording medium P having passed through the fixing device 86 is ejected to the outside of the copier 500 via the rollers of an ejection roller pair 29. The recording medium P ejected to the outside of the copier 500 by the ejection roller pair 29 is sequentially stacked on a stacking unit 30 as an output image. Thus, a sequence of image formation processes performed in the copier 500 is completed.

Next, a configuration and operation of the developing device 50 in the image formation unit 46 are described in further detail below.

Here, the image formation unit 46Y corresponding to yellow will be described as an example, but the same applies to the image formation units 46M, 46C, and 46K of other colors.

As illustrated in FIG. 2, the developing device 50Y includes a developing roller 51Y, a doctor blade 52Y, two developer conveying screws 55Y, and a toner density detection sensor 56Y. The developing roller 51Y faces the photoconductor 41Y, and the doctor blade 52Y faces the developing roller 51Y. The two developer conveying screws 55Y are disposed in two developer containers (53Y, 54Y). The developing roller 51Y includes a magnet roller secured inside and a sleeve rotating around the magnet roller. The first developer container 53Y and the second developer container 54Y contain two-component developer G including a carrier (carrier particles) and a toner (toner particles). The second developer container 54Y communicates, via an opening formed on an upper side thereof, with a downward toner conveyance passage 64Y. The toner density detection sensor 56Y detects the toner density in the developer G in the second developer container 54Y.

The developer G in the developing device 50 circulates between the first developer container 53Y and the second developer container 54Y while being stirred by the two developer conveying screws 55Y. The developer G in the first developer container 53Y is supplied and carried on the sleeve surface of the developing roller 51Y by the magnetic field formed by the magnet roller in the developing roller 51Y while being conveyed to one of the developer conveying screws 55Y. The sleeve of the developing roller 51Y is rotationally driven counterclockwise as indicated by an arrow in FIG. 2, and the developer G carried on the developing roller 51Y moves on the developing roller 51Y with the rotation of the sleeve. At that time, the toner particles in the developer G are charged through friction with carrier particles in the developer G to have a potential in the polarity opposite to the polarity of carrier particles, and the toner particles are electrostatically attracted to the carrier particles and carried on the developing roller 51Y together with the carrier particles by the magnetic field generated on the developing roller 51Y.

The developer G carried on the developing roller 51Y is transported as indicated by an arrow direction in FIG. 2 to a doctor portion where the doctor blade 52Y faces the developing roller 51Y. When the developer G on the developing roller 51Y passes through the doctor portion, the amount of the developer G is regulated to an appropriate amount, and then the developer G is conveyed to a developing region which is a position opposed to the photoconductor 41Y. In the developing region, the toner particles in the developer G are attracted to the latent image formed on the photoconductor 41Y due to the effect of the developing electrical field generated between the developing roller 51Y and the photoconductor 41Y. The developer G remaining on the surface of the developing roller 51Y having passed through the developing region reaches above the first developer container 53Y with the rotation of the sleeve, and is separated from the developing roller 51Y at this position.

The concentration of the toner in the developer G contained in the developing device 50Y is adjusted within a predetermined range. Specifically, the toner contained in the toner container 32Y is supplied into the second developer container 54Y via the toner supply device 60Y to be described later according to the consumption amount of the toner contained in the developer G in the developing device 50Y. The toner supplied into the second developer container 54Y circulates between the first developer container 53Y and the second developer container 54Y while being mixed and stirred together with the developer G by the two developer conveying screws 55Y.

Next, the toner supply devices 60Y, 60M, 60C, and 60K will be described.

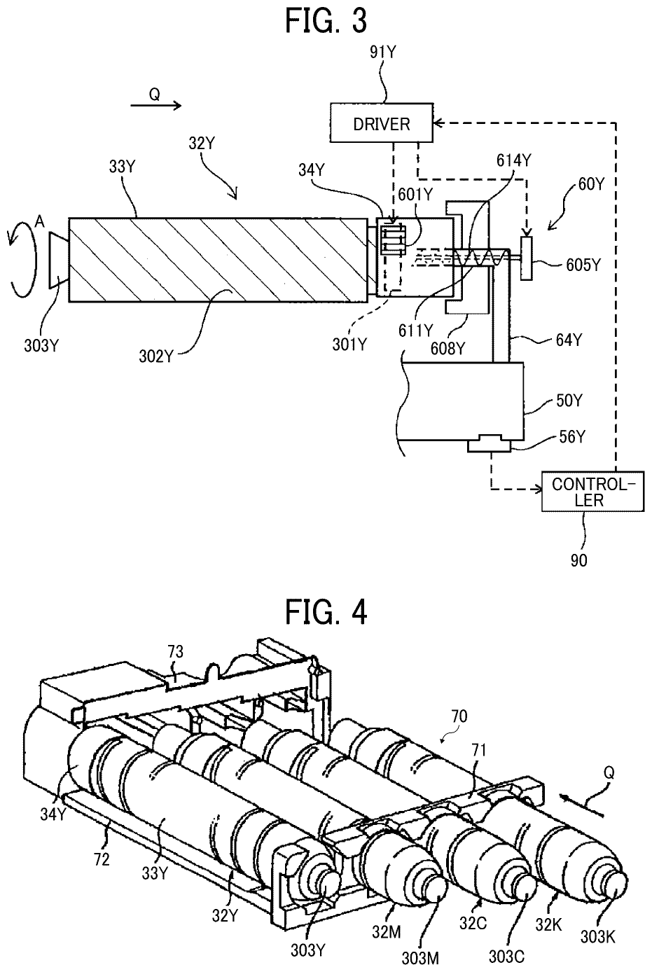

FIG. 3 is a schematic diagram illustrating a state in which the toner container 32Y is attached to the toner supply device 60Y, and FIG. 4 is a schematic perspective view illustrating a state in which four toner containers 32Y, 32M, 32C, and 32K are installed in the toner container housing 70.

Toners in the toner containers 32Y, 32M, 32C, and 32K attached to the toner container housing 70 of the printer unit 100 are appropriately supplied into the developing devices 50Y, 50M, 50C, and 50K according to toner consumption in the developing devices 50Y, 50M, 50C, and 50K of the respective colors. At this time, the toner in the toner containers 32Y, 32M, 32C, and 32K is supplied by the toner supply devices 60Y, 60M, 60C, and 60K provided for the respective toner colors. The four toner supply devices 60Y, 60M, 60C, and 60K and the toner containers 32Y, 32M, 32C, and 32K have substantially the same structure except that the colors of the toners used in the processes of image formation are different from each other. Therefore, hereinafter, the toner supply device 60Y and the toner container 32Y corresponding to yellow will be described, and the description of the toner supply devices 60M, 60C, and 60K and the toner containers 32M, 32C, and 32K corresponding to the other three colors will be appropriately omitted.

Each of the toner supply devices 60Y, 60M, 60C, and 60K includes the toner container housing 70, a conveying nozzle 611, a conveying screw 614, a downward toner conveyance passage 64, and a container rotation driver 91.

When the toner container 32Y moves in the direction of the arrow Q in FIG. 3 and is attached to the toner container housing 70 of the printer unit 100, the conveying nozzle 611Y of the toner supply device 60Y is inserted from the container front end side of the toner container 32Y in conjunction with the attachment operation. With this action, the interior of the toner container 32Y communicates with the conveying nozzle 611Y.

The toner container 32Y according to the present embodiment is a substantially cylindrical toner bottle. The toner container 32Y mainly includes a container front end cover 34Y as a securing unit held in the toner container housing 70 in a non-rotating manner, and a container body 33Y as a rotator in which a container gear 301Y is integrally formed. The container body 33Y is held so as to be relatively rotatable with respect to the container front end cover 34Y.

The toner container housing 70 mainly includes a container cover receiver 73, a container receiver 72, and an insertion port part 71. The container cover receiver 73 is a part for holding the container front end cover 34Y of the toner container 32Y, and the container receiver 72 is a part for holding the container body 33Y of the toner container 32Y. The insertion port part 71 is a part that forms an insertion port at the time of the attachment operation of the container receiver 72 and the toner container 32Y.

When the main body cover installed on the front side of the copier 500 (front side in the direction perpendicular to the paper surface of FIG. 1) is opened, the insertion port part 71 of the toner container housing 70 is exposed. Then, in a state where the longitudinal direction of each of the toner containers 32Y, 32M, 32C, and 32K is the horizontal direction, the attachment/detachment operation of each of the toner containers 32Y, 32M, 32C, and 32K (attachment/detachment operation in which the longitudinal direction of the toner container 32 is the attachment/detachment direction) is performed from the front side of the copier 500. The set cover 608Y in FIG. 3 is a part of the container cover receiver 73 of the toner container housing 70.

The longitudinal length of the container receiver 72 is approximately equal to the longitudinal length of the container body 33Y. In addition, the container cover receiver 73 is disposed on the container front end side in the longitudinal direction (attachment/detachment direction) of the container receiver 72, and the insertion port part 71 is disposed on one end side in the longitudinal direction of the container receiver 72. Therefore, with the attachment operation of the toner container 32Y, the container front end cover 34Y slides on the container receiver 72 for a while after passing through the insertion port part 71, and is then attached to the container cover receiver 73.

In a state where the container front end cover 34Y is attached to the container cover receiver 73, rotational drive is input from the container rotation driver 91Y including a drive motor and a drive gear to the container gear 301Y included in the container body 33Y via the container drive gear 601Y. As a result, the container body 33Y is rotationally driven in an arrow A direction in FIG. 3. When the container body 33Y rotates, the toner stored in the container body 33Y is conveyed from the left side to the right side in FIG. 3 along the container body longitudinal direction by a spiral rib 302Y formed in a spiral shape on the inner peripheral surface of the container body 33Y. As a result, the toner is supplied from the container front end cover 34Y side into the conveying nozzle 611Y.

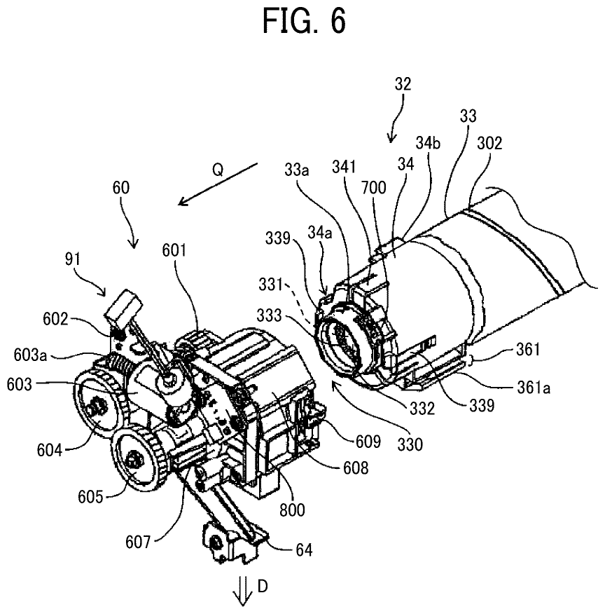

The conveying screw 614Y is disposed in the conveying nozzle 611Y, and when the rotational drive is input from the container rotation driver 91Y to the conveying screw gear 605Y, the conveying screw 614Y rotates to convey the toner supplied into the conveying nozzle 611Y. A downstream end of the conveying nozzle 611Y in the conveyance direction leads to the downward toner conveyance passage 64Y, and as indicated by arrow D in FIGS. 2 and 6, the toner conveyed by the conveying screw 614Y falls by the own weight of the toner on the downward toner conveyance passage 64Y and is supplied into the developing device 50Y (second developer container 54Y).

Each of the toner containers 32Y, 32M, 32C, and 32K, which may be collectively referred to as toner container(s) 32 in the following description, is replaced with a new container when the stored toner is discharged and becomes empty. A handle 303 (303Y, 303M, 303C, or 303K) is disposed at an end of the toner container 32 on an opposite side of the container front end cover 34 in the longitudinal direction, and the operator can pull out to remove the attached toner container 32 by gripping the handle 303 at the time of replacement.

A controller 90 may calculate the toner consumption amount based on the image information used in the exposure device 47 described above, and the controller 90 may determine that it is necessary to supply the toner to the developing device 50Y. In addition, the controller 90 may detect that the toner density in the developing device 50Y has decreased based on the detection result of the toner density detection sensor 56Y. In these cases, the container rotation driver 91Y is rotationally driven by the control of the controller 90, and the container body 33Y of the toner container 32Y and the conveying screw 614Y are rotated for a predetermined time to perform toner supply to the developing device 50Y. In addition, since the conveying screw 614Y disposed in the conveying nozzle 611Y rotates to supply toner, the rotation speed of the conveying screw 614Y is detected to accurately calculate the amount of toner supplied from the toner container 32Y.

In a case where the amount of supplied toner cumulatively calculated from when the toner container 32Y is attached reaches the amount of toner in the toner container 32Y at the time of attachment, it is determined that there is no toner in the toner container 32Y, and a message prompting replacement of the toner container 32Y is displayed on the display unit of the copier 500. In addition, even when the toner density detection sensor 56Y detects a decrease in the toner density, supply operation is performed, and the determination as to whether the toner density has recovered is repeated a plurality of times, the recovery of the toner density may not be detected by the toner density detection sensor 56Y. In this case also, it is determined that there is no toner in the toner container 32Y, and a message prompting replacement of the toner container 32Y is displayed on the display unit of the copier 500.

In the toner supply device 60Y according to the present embodiment, the toner supplied into the conveying nozzle 611Y is conveyed by the conveying screw 614Y, but the configuration for conveying the toner supplied into the conveying nozzle 611Y is not limited to a configuration with the screw member. For example, the conveying force may be applied by a member other than the screw member in such a configuration in which a negative pressure is generated in the opening of the conveying nozzle 611Y using a powder pump.

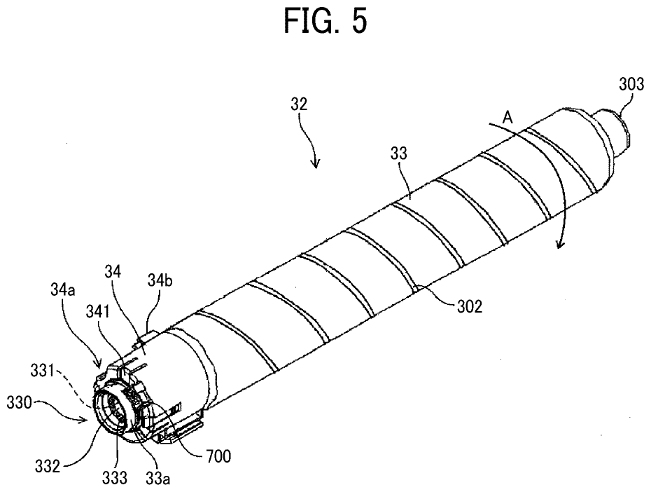

FIG. 5 is a perspective explanatory view of the toner container 32 according to the present embodiment.

FIG. 6 is a perspective explanatory view of the toner supply device 60 before the toner container 32 is attached and the front end of the toner container 32.

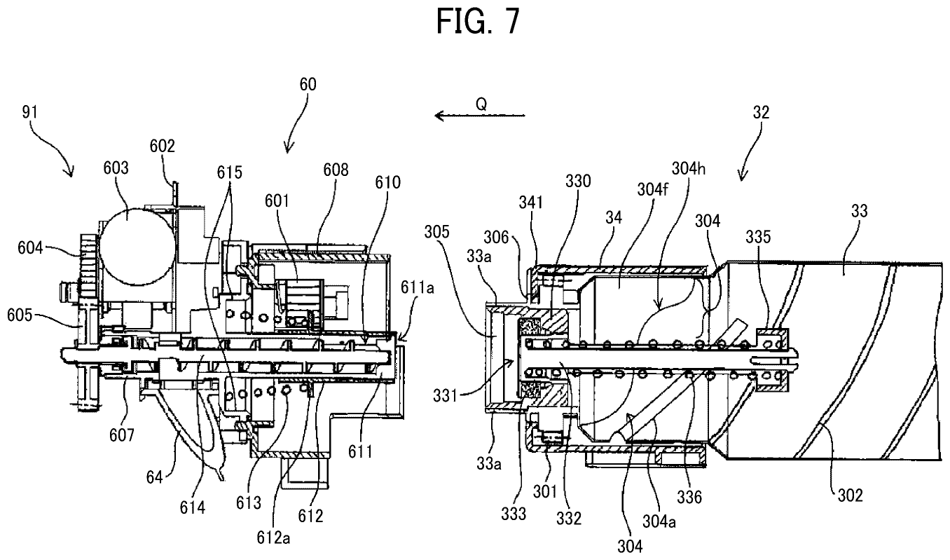

FIG. 7 is a cross-sectional explanatory view of the toner supply device 60 before the toner container 32 is attached and the end portion of the toner container 32 on the container front end side.

The toner supply device 60 includes a conveying nozzle 611 including a conveying screw 614 therein. The toner supply device 60 includes a nozzle shutter 612. The nozzle shutter 612 closes the nozzle opening 610 formed in the conveying nozzle 611 at the non-attachment time (the state of FIGS. 6 and 7) before the toner container 32 is attached, and opens the nozzle opening 610 at the attachment time when the toner container 32 is attached. On the other hand, the toner container 32 has, at the center of the leading end surface thereof, a nozzle receiving port 331 as a developer discharge port into which the conveying nozzle 611 is inserted at the time of attachment, and includes a container shutter 332 that closes the nozzle receiving port 331 at the time of non-attachment.

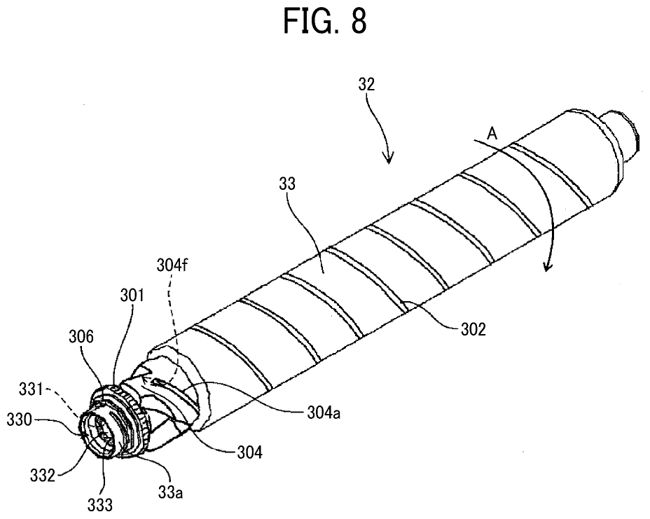

FIG. 8 is a perspective explanatory view of the toner container 32 in a state where the container front end cover 34 is removed.

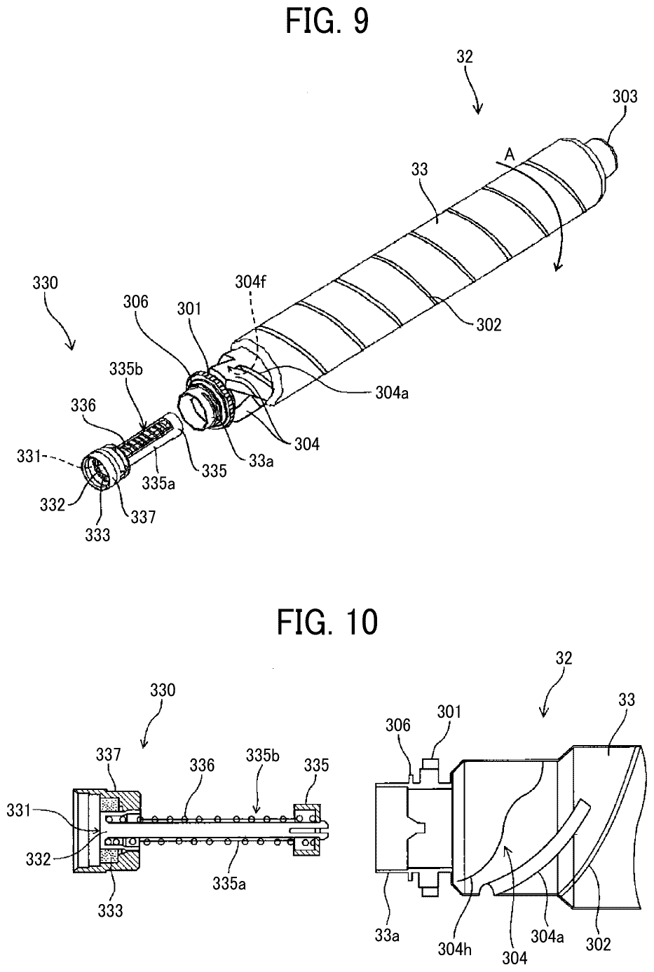

FIG. 9 is a perspective explanatory view of the toner container 32 in a state where the nozzle receiver 330 is removed from the container body 33.

FIG. 10 is a cross-sectional explanatory view of the toner container 32 in a state where the nozzle receiver 330 is removed from the container body 33.

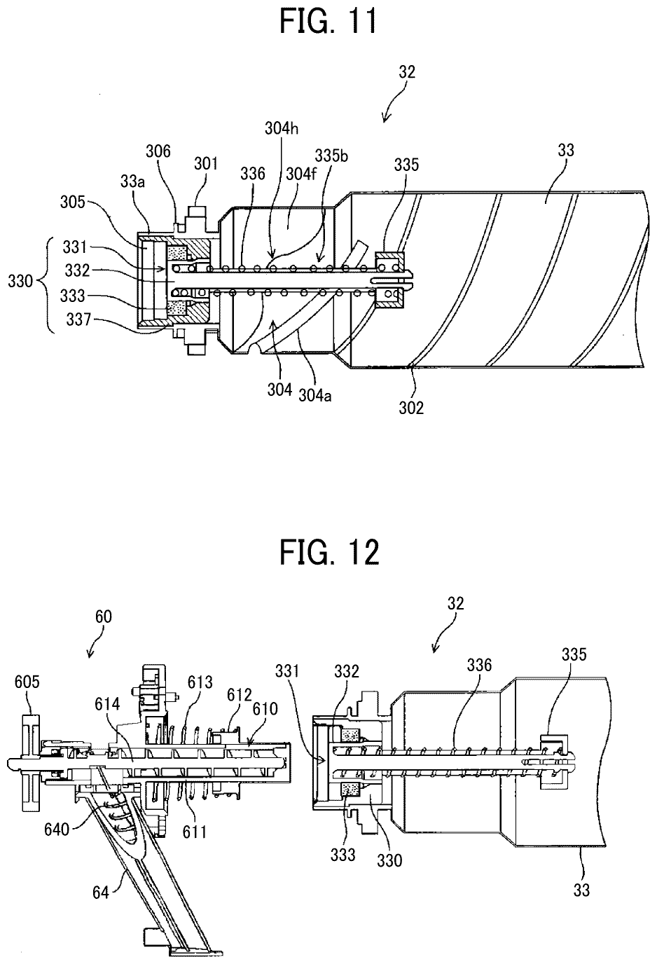

FIG. 11 is a cross-sectional explanatory view of the toner container 32 in a state where the nozzle receiver 330 is attached to the container body 33 from the state of FIG. 10 (the toner container 32 in a state where the container front end cover 34 is removed similarly to FIG. 8).

As illustrated in FIG. 8, the toner container 32 from which the container front end cover 34 is removed includes a container body 33 and a nozzle receiver 330 forming a nozzle receiving port 331. The container body 33 has a substantially cylindrical shape and is configured to rotate about a central axis of the cylinder as a rotation shaft. Hereinafter, a direction parallel to the rotation shaft is referred to as a “rotation shaft direction”, and in the rotation shaft direction, an end of the toner container 32 on which the nozzle receiving port 331 is formed (a side on which the container front end cover 34 is disposed) is referred to as a “container front end side”. An end of the toner container 32 on which the handle 303 is disposed (an end opposite to the container front end) is referred to as “container rear end side”.

The longitudinal direction of the toner container 32 in the present embodiment is a rotation shaft direction, and the rotation shaft direction is a horizontal direction in a state where the toner container 32 is attached to the toner supply device 60. The container body 33 has a larger outer diameter on the container rear end side than an outer diameter on the container front end side with respect to the container gear 301, and has a spiral rib 302 formed on the inner peripheral surface thereof. As the container body 33 rotates in the arrow A direction illustrated in the drawing, the spiral rib 302 gives the toner in the container body 33 the conveyance force from one end (the container rear end side) to another end (the container front end side) in the rotation shaft direction.

The container body 33 has, on an inner wall on the container front end side, a scooping portion 304 that pumps up the toner conveyed to the container front end side by the spiral rib 302 of the container body 33 upward when the container body 33 rotates. The scooping portion 304 includes a convex portion 304h and a scooping wall surface 304f. The convex portion 304h is a portion (raised portion) that is raised inside the container body 33 so as to form a ridge of mountain toward the rotation center of the container body 33 while forming a spiral. The scooping wall surface 304f is a wall surface on the downstream side as viewed in the container rotation direction among wall surfaces of a raised portion leading from the convex portion 304h (ridge) to the inner wall of the peripheral surface of the container body 33. When the scooping wall surface 304f is downward, the toner that has entered the internal space facing the scooping portion 304 due to the conveyance force of the spiral rib 302 is scooped upward by the scooping wall surface 304f in accordance with the rotation of the container body 33. As a result, the toner can be drawn up above the inserted conveying nozzle 611.

As illustrated in, e.g., FIG. 8, the scooping portion 304 has, on the inner peripheral surface thereof, a spiral rib 304a of the scooping portion formed in a spiral shape so as to convey the toner inside similarly to the spiral rib 302.

The container body 33 has a container gear 301 at a position closer to the container front end side with respect to the scooping portion 304. The container front end cover 34 is provided with a gear exposure opening 34a so that a part of the container gear 301 is exposed in a state of being attached to the container body 33. When the toner container 32 is attached to the toner supply device 60, the container gear 301 exposed from the gear exposure opening 34a meshes with the container drive gear 601 on the toner supply device 60 side.

The container body 33 has a container opening portion 33a of a cylindrical shape at a position closer to the container front end side with respect to the container gear 301 is. A receiver securing unit 337 of the nozzle receiver 330 is press-fitted in the container opening portion 33a to secure the nozzle receiver 330 to the container body 33. The method for securing the nozzle receiver 330 is not limited to press-fitting. The nozzle receiver 330 may be secured by being glued or screwed. After the toner is replenished from an opening 305 of the container opening portion 33a into the container body 33 of the toner container 32, the nozzle receiver 330 is secured to the container opening portion 33a of the container body 33.

The container body 33 has a cover-hook catch 306 at an end of the container opening portion 33a closer to the container gear 301 side. The container front end cover 34 is attached to the toner container 32 (the container body 33) in the state illustrated in FIG. 8 from the container front end side (the lower left side in FIG. 8). The container body 33 penetrates the container front end cover 34 in the rotation shaft direction, and a cover hook 341 at an upper portion of the container front end cover 34 is hooked to the cover-hook catch 306. The container 33 has the cover-hook catch 306 extending over the entire outer peripheral surface of the container opening portion 33a, and when the cover hook 341 is hooked by the cover-hook catch 306, the container body 33 can rotate relative to the container front end cover 34.

The nozzle receiver 330 includes a container shutter support, a container shutter 332, a container seal 333, a container shutter spring 336, and a receiver securing unit 337. The container shutter support includes a shutter rear end support 335, a shutter side support 335a, and a receiver securing unit 337, and the container shutter spring 336 includes a coil spring.

When the toner container 32 is attached, the nozzle shutter flange 612a abuts against the rib of the receiver securing unit 337, the relative position of the nozzle shutter 612 is secured to the toner container 32, and then the nozzle opening 610 starts opening. On the other hand, when the toner container 32 is removed, even if the conveying nozzle 611 starts to come out of the toner container 32, in a state where the nozzle opening 610 is opened, the relative position of the nozzle shutter 612 with respect to the toner container 32 does not change due to a biasing force of the nozzle shutter spring 613.

When the toner container 32 is pulled out, the relative position of the toner container 32 with respect to the conveying nozzle 611 changes, so that the relative position of the nozzle shutter 612 with respect to the conveying nozzle 611 also changes, and the nozzle shutter 612 starts to close the nozzle opening 610. At this time, along with the operation of pulling out the toner container 32, the distance between the toner container 32 and the container setting unit 615 increases. As a result, the nozzle shutter spring 613 starts to return to a natural length by the restoring force of the nozzle shutter spring 613, and the biasing force with respect to the nozzle shutter 612 starts to decrease.

Furthermore, when the toner container 32 is pulled out and the nozzle shutter 612 completes the closing of the nozzle opening 610, a part of the nozzle shutter 612 abuts against a part of the conveying nozzle 611. Due to this abutment, the relative position of the nozzle shutter 612 with respect to the conveying nozzle 611 is secured, and the abutment of the nozzle shutter flange 612a with respect to the rib of the receiver securing unit 337 is released. Thereafter, when the toner container 32 is further pulled out, the nozzle shutter 612 comes out of the toner container 32 together with the conveying nozzle 611.

The nozzle receiver 330 secured to the container body 33 rotates with the container body 33 as the container body 33 rotates. At this time, the shutter side supports 335a of the nozzle receiver 330 rotate around the conveying nozzle 611 of the toner supply device 60. Accordingly, the shutter side supports 335a that are rotating pass a space close to and above the nozzle opening 610 located in the upper portion of the conveying nozzle 611. If the toner momentarily accumulates above the nozzle opening 610, the shutter side supports 335a cross and break the accumulated toner. This structure can reduce the aggregation of accumulated toner while the copier 500 is left unused, thus preventing the poor conveyance of toner at restart of the copier 500. On the other hand, when the shutter side supports 335a are positioned on the lateral sides of the conveying nozzle 611 and the nozzle opening 610 faces the shutter support opening 335b, the toner is supplied from the container body 33 into the conveying nozzle 611.

The container front end cover 34 of the toner container 32 is slid and moved on the container receiver 72 of FIG. 4 when attached to the toner supply device 60. In FIG. 4, grooves that extend from the insertion port part 71 to the container cover receiver 73 are formed immediately below the four toner containers 32 with the axial direction of the container body 33 as the longitudinal direction. The container front end cover 34 has a pair of slide guides 361 on both side surfaces of the lower portion thereof so that the container front end cover 34 can slide and move along the grooves. Specifically, the groove of the container receiver 72 has a pair of slide rails protruding from both side surfaces thereof. The slide guide 361 has a slide groove 361a in parallel with the rotation shaft of the container body 33 so as to sandwich the pair of slide rails vertically. Furthermore, the container front end cover 34, when attached to the toner supply device 60, includes a container locking portion 339 that is coupled to a supply device side locking member 609 on the set cover 608.

In addition, the container front end cover 34 is provided with an ID tag (ID chip) 700 recording therein data such as a usage status of the toner container 32. Furthermore, the container front end cover 34 is provided with a color incompatible rib 34b that prevents the toner containers 32 having different colors of the stored toner from being attached to the set cover 608 of another color. As described above, the posture of the container front end cover 34 on the supply device 60 is determined when the slide guide 361 is engaged with the slide rail of the container receiver 72 at the time of attachment. Then, it is possible to smoothly align the container locking portion 339 with the supply device side locking member 609 and align the ID tag 700 described later with the body-side connector 800.

Next, the toner supply device 60 according to the present embodiment will be described.

As illustrated in FIG. 6 and FIG. 7, the toner supply device 60 includes a nozzle holder 607 securing the conveying nozzle 611 to the frame 602 of the copier 500 body, and a set cover 608 is secured to the nozzle holder 607. Furthermore, the downward toner conveyance passage 64 disposed to communicate with the inside of the conveying nozzle 611 from below the conveying nozzle 611 is secured to the nozzle holder 607.

FIG. 12 is an explanatory diagram for explaining an internal structure of the toner supply device and the toner container.

As the downward toner conveyance passage 64, a swing spring 640 may be disposed inside as in the configuration illustrated in FIG. 12. One end of the swing spring 640 is engaged with a rotation shaft of the conveying screw 614, and is configured to move up and down with the rotation of the conveying screw 614. The swing spring 640 scrapes off the toner stagnating and adhering to the vicinity of the inner wall surface of the downward toner conveyance passage 64 which is a tubular member by the vertical movement.

A container rotation driver 91 is secured to the frame 602. The container rotation driver 91 includes a drive motor 603 and a container drive gear 601, and further includes a worm gear 603a that transmits rotational drive of the drive motor 603 to a rotation shaft of the container drive gear 601. A drive transmission gear 604 is secured to the rotation shaft of the container drive gear 601, and meshes with the conveying screw gear 605 secured to the rotation shaft of the conveying screw 614. With such a configuration, when the drive motor 603 is rotated and driven, the toner container 32 can be rotated via the container drive gear 601 and the container gear 301. In addition, the toner container 32 can be rotated, and the conveying screw 614 can be rotated via the drive transmission gear 604 and the conveying screw gear 605.

A clutch may be disposed in a drive transmission path from the drive motor 603 to the container gear 301 or a drive transmission path from the drive motor 603 to the conveying screw gear 605. Providing such a clutch can implement a configuration in which one of the toner container 32 and the conveying screw 614 is rotated when the drive motor 603 is rotationally driven.

Next, a process of attaching the toner container 32 to the toner supply device 60 will be described.

When the toner container 32 is moved in the direction of the toner supply device 60 as indicated by an arrow Q in FIG. 6 and FIG. 7, a nozzle leading end 611a of the conveying nozzle 611 is in contact with the end surface on the container front end side of the container shutter 332. Furthermore, when the toner container 32 is moved in the direction of the toner supply device 60, the conveying nozzle 611 presses the end surface on the container front end side of the container shutter 332. When the container shutter 332 is pressed, the container shutter spring 336 contracts, and accordingly, the container shutter 332 is pushed into the inner side (container rear end side) of the toner container 32, and the nozzle leading end side of the conveying nozzle 611 is inserted into the nozzle receiving port 331. At this time, a nozzle shutter tubular portion that is closer to the nozzle leading end side with respect to the nozzle shutter flange 612a in the nozzle shutter 612 is also inserted into the nozzle receiving port 331 together with the conveying nozzle 611.

Furthermore, the toner container 32 is moved in the direction of the toner supply device 60, so that the surface of the nozzle shutter flange 612a on the side opposed to the nozzle shutter spring receiving surface is in contact with the end surface on the container front end side of the container seal 333. Furthermore, the container seal 333 is slightly crushed to abut against the nozzle shutter abutment rib. As a result, the relative position of the nozzle shutter 612 in the rotation shaft direction is secured to the toner container 32.

The toner container 32 is further moved in the direction of the toner supply device 60, so that the conveying nozzle 611 is further inserted into the toner container 32. At this time, the nozzle shutter 612 abutting against the nozzle shutter abutment rib is pushed back toward the nozzle base side with respect to the conveying nozzle 611. As a result, the nozzle shutter spring 613 contracts, and the relative position of the nozzle shutter 612 with respect to the conveying nozzle 611 moves to the nozzle base side. With the movement of the relative position, the nozzle opening 610 covered with the nozzle shutter 612 is exposed inside the container body 33, and the inside of the container body 33 and the inside of the conveying nozzle 611 communicate with each other.

In a state where the conveying nozzle 611 is inserted into the nozzle receiving port 331, the biasing force of the container shutter spring 336 and the nozzle shutter spring 613 in a contracted state causes a force to act in a direction (a direction opposite to the arrow Q in the drawing) in which the toner container 32 is pushed back with respect to the toner supply device 60. However, when the toner container 32 is attached to the toner supply device 60, the toner container 32 is moved in the direction of the toner supply device 60 to a position where the container locking portion 339 is coupled to the supply device side locking member 609 against this force. As a result, the biasing force of the container shutter spring 336 and the nozzle shutter spring 613 and the catching of the container locking portion 339 with the supply device side locking member 609 act. The acting of the biasing force and the catching positions the toner container 32 in the rotation shaft direction with respect to the toner supply device 60.

In a state where the positioning in the rotation shaft direction is performed as described above, the outer peripheral surface of the container opening portion 33a is slidably fitted to the inner peripheral surface of the container setting unit 615. Therefore, the toner container 32 is positioned with respect to the toner supply device 60 in the planar direction orthogonal to the rotation shaft. Accordingly, attachment of the toner container 32 to the toner supply device 60 is completed.

When the drive motor 603 is rotationally driven in a state where the attachment of the toner container 32 is completed, the container body 33 of the toner container 32 and the conveying screw 614 in the conveying nozzle 611 rotate. When the container body 33 rotates, the toner in the container body 33 is conveyed to the container front end side of the container body 33 by the spiral rib 302. When the container body 33 rotates, the scooping portion 304 lifts the toner that has reached the scooping portion 304 by this conveyance above the nozzle opening 610. When the toner lifted to above the nozzle opening 610 falls into the nozzle opening 610, the toner is supplied into the conveying nozzle 611. The toner supplied into the conveying nozzle 611 is conveyed by the conveying screw 614 and supplied to the developing device 50 through the downward toner conveyance passage 64.

Next, the ID tag (ID chip) 700 included in the toner container 32 according to the present embodiment will be described.

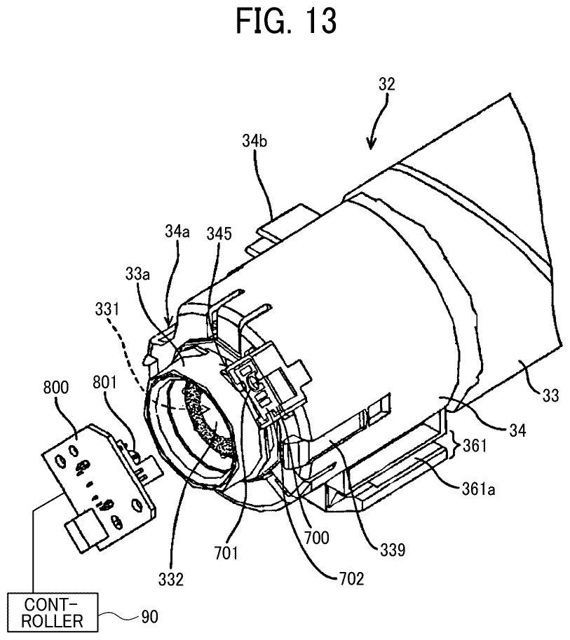

FIG. 13 is a perspective explanatory view of the connector 800 secured to the toner supply device 60 and the container front end of the toner container 32.

The toner container 32 according to the present embodiment includes an ID tag 700 and an ID-tag holding mechanism 345 that holds the ID tag 700. The ID tag 700 serves as an information storage device attached to an exterior of the container front end cover 34.

The communication system of the ID tag 700 according to the present embodiment is a contact system. Therefore, the connector 800 on the toner supply device 60 side is disposed at a position facing the ID tag 700 of the container front end cover 34 when attached to the toner supply device 60. The ID tag 700 has an ID tag hole 701 for positioning, and when the toner container 32 is attached to the toner supply device 60, a positioning pin 801 of the connector 800 is inserted into the ID tag hole 701. The ID tag hole 701 has a shape in which the ID tag 700 can be displaced in a direction orthogonal to the rotation shaft direction of the toner container 32 and parallel to the substrate surface of the ID tag 700 with respect to the connector 800 into which the positioning pin 801 is inserted, the shape being, for example, a long hole shape elongated in the displaceable direction.

In the present embodiment, as illustrated in FIG. 13, the toner container 32 in the attached state is disposed such that the tag surface of the ID tag 700 (the surface having the electrode pad of the ID tag) is not parallel to the vertical plane, and the tag surface is oblique to the vertical plane.

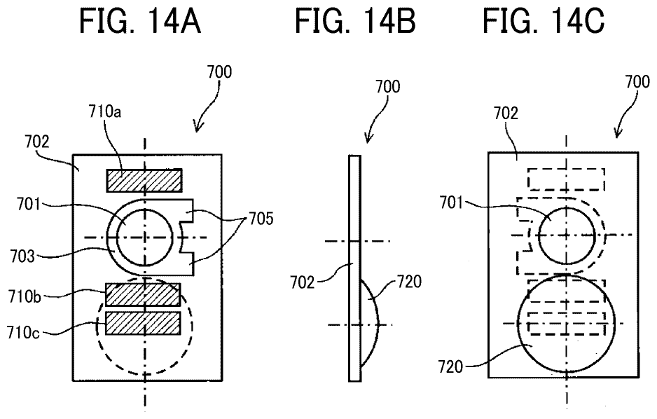

FIG. 14 is a three-view diagram illustrating an example of the ID tag 700, FIG. 14A is a front view of the ID tag 700 as viewed from a side with which the connector 800 is in contact, FIG. 14B is a side view, and FIG. 14C is a rear view.

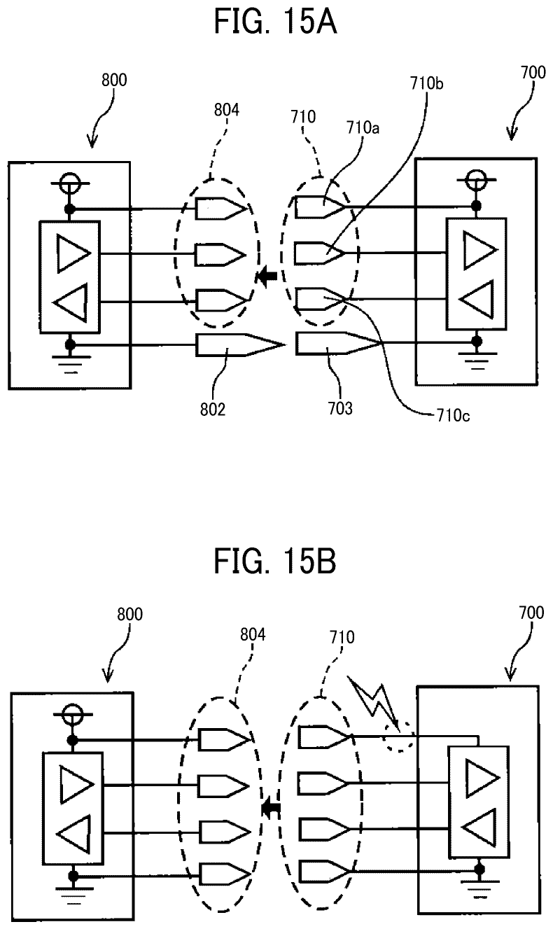

FIGS. 15A and 15B are circuit diagrams each illustrating an electric circuit of the ID tag 700 and an electric circuit of the connector 800.

The substrate 702 of the ID tag 700 of the present embodiment has a plurality of metal pads 710 (710a, 710b, 710c) as container-side electrode units. In addition, the substrate 702 of the ID tag 700 has an ID tag hole 701, and the ID tag hole 701 has a ground terminal 703 for grounding as a container-side electrode unit formed in a peripheral edge portion thereof. As illustrated in FIG. 14A, in the ground terminal 703 on the surface of the substrate 702 of the present embodiment, two ground terminal protruding portions 705 are extended to an annular portion. In addition, as illustrated in FIG. 14C, on the back surface of the substrate 702 of the ID tag 700 is provided with a protective member 720 that is made of a resin material such as hemispherical epoxy and covers and protects the information storage. The arrangement of the ID tag hole 701 is appropriately set according to the shape of the substrate 702 and the configuration and arrangement of the back surface of, for example, the protective member 720.

A positioning pin 801 mounted on the toner supply device 60 side (image forming apparatus body side) of the connector 800 has a grounding body-side terminal 802 as a body-side electrode unit. The grounding body-side terminal 802 is a plate-like (or linear) metal member, a part of which is housed in a hollow portion of the positioning pin 801 formed integrally with the connector 800, and protrudes from a cylindrical outer peripheral surface of the positioning pin 801.

Furthermore, the positioning pin 801 is provided with three communication body-side terminals 804 as body-side electrode units. These communication body-side terminals 804 are also plate-like (or linear) metal members, and are mounted on the connector 800 with one end side as a secured end and another end side (toner container side) as a free end.

With the attachment operation of the toner container 32 to the toner supply device 60, the body-side terminal 804 is in contact with a substantially central portion of the metal pad 710 of the ID tag 700 of the toner container 32 in the longitudinal direction (left-right direction in FIG. 14A). Then, when the attachment operation of the toner container 32 further proceeds, the ID tag 700 further approaches the connector 800 side, and the body-side terminal 804 is pressed against the metal pad 710 of the ID tag 700 and elastically deformed, and the contact pressure with respect to the metal pad 710 is gradually increased. When attachment of the toner container 32 to the toner supply device 60 is completed, the body-side terminal 804 comes into contact with the metal pad 710 of the ID tag 700 at a predetermined contact pressure.

Here, a foreign matter such as toner scattered in the apparatus is likely to adhere between the ID tag 700 on the toner container 32 and the connector 800 on the toner supply device 60 side (image forming apparatus body side). Then, when the attached foreign matter accumulates, a contact failure occurs between the ground terminal 703 and the metal pad 710 of the ID tag 700 and the grounding body-side terminal 802 and the communication body-side terminal 804 of the connector 800, and thus causes a communication failure.

In order to reduce such a communication failure, for example, in order to discharge the toner from the toner container, a configuration is considered in which the relative position between the ground terminal 703 and the metal pad 710 of the ID tag 700 and the grounding body-side terminal 802 and the communication body-side terminal 804 of the connector 800 in conjunction with the operation (toner conveyance operation) of rotating the container body 33Y in the arrow A direction (normal direction) in FIG. 3. As a result of the change in the relative position, the toner adhering between the ID tag 700 side and the connector 800 side can be removed, and contact recovery can be performed. However, in this configuration, since the relative position is constantly changed during the toner conveyance operation for discharging the toner from the toner container, the contact is likely to be worn, and defects such as shortening of the life are likely to occur.

In the present embodiment, the container body 33 of the toner container 32 does not rotate in the rotation direction (normal direction) A during the toner conveyance operation but in a reverse direction B opposite to the normal direction, so that the relative positions between the ground terminal 703 and the metal pad 710 of the ID tag 700 and the grounding body-side terminal 802 and the communication body-side terminal 804 of the connector 800 are changed. As a result, when the container body 33 is rotated in the reverse direction B at a necessary timing other than during the toner conveyance operation, the relative position is changed, and the contact failure due to, for example, toner adhesion can be eliminated. According to this configuration, since it is not necessary to change the relative position between the ground terminal 703 and the metal pad 710 of the ID tag 700 and the grounding body-side terminal 802 and the communication body-side terminal 804 of the connector 800 at the time of rotation in the rotation direction (normal direction) during the toner conveyance operation, wear of the contact can be reduced.

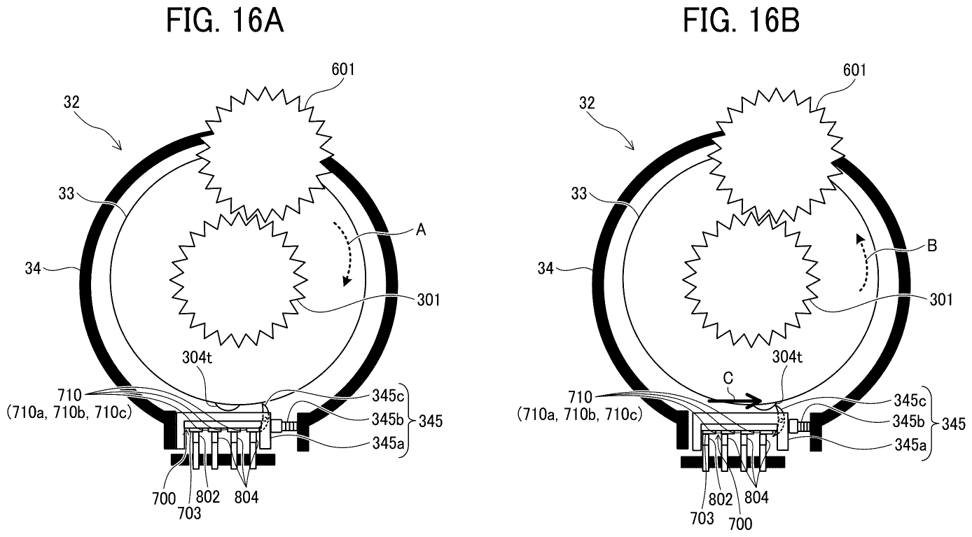

FIG. 16A is an explanatory view schematically illustrating the holding mechanism 345 of the ID tag 700 when the container body 33 of the toner container 32 is rotated in the normal direction A. FIG. 16B is an explanatory view schematically illustrating the holding mechanism 345 of the ID tag 700 when the container body 33 of the toner container 32 is rotated in the reverse direction B opposite to the normal direction A.

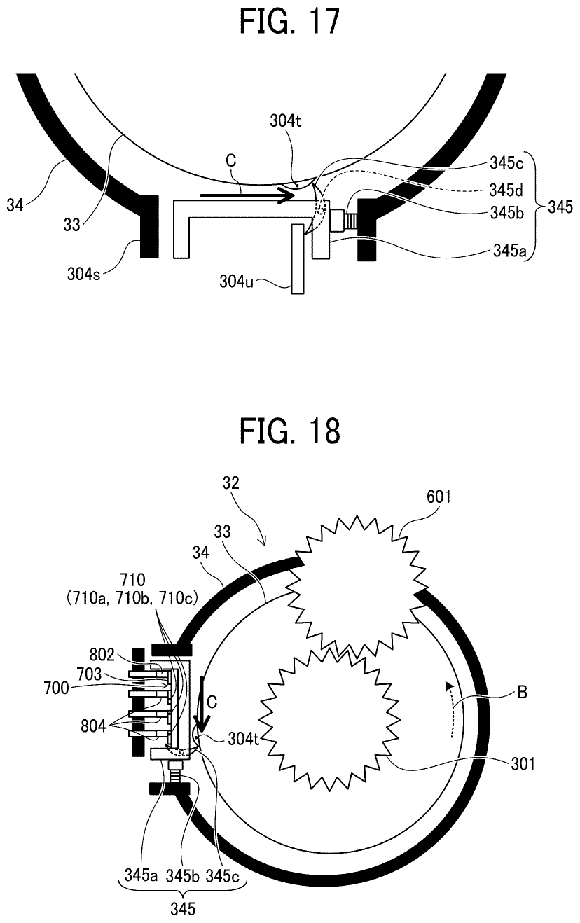

FIG. 17 is an enlarged view illustrating a configuration of the holding mechanism 345 when the container body 33 of the toner container 32 is rotated in the reverse direction B opposite to the normal direction A. In FIG. 17, the ID tag 700 is omitted for the sake of explanation.

The holding mechanism 345 in the present embodiment includes a tag holder 345a holding the ID tag 700, a spring 345b that biases the tag holder 345a, and a movable claw 345c that is a moving member as an engaged part.

The tag holder 345a holds the attached ID tag 700. The tag holder 345a is supported to be displaceable in a direction orthogonal to the rotation shaft direction of the toner container 32 and parallel to the substrate surface of the ID tag 700 (left-right direction in FIGS. 16A and 16B) with respect to the container front end cover 34 as a securing unit.

The spring 345b includes a compression spring that biases the tag holder 345a in one direction (left direction in FIGS. 16A and 16B) along the displaceable direction of the tag holder 345a. As illustrated in FIG. 16A, the biasing force of the spring 345b causes the tag holder 345a to be pressed against the holder receiving wall 304s of the container front end cover 34. Accordingly, the tag holder 345a is positioned at a predetermined position on the container front end cover 34.

The movable claw 345c is a member that is attached to a rotation shaft 345d on the tag holder 345a and is pivotable around the rotation shaft 345d. The rotation shaft 345d extends in a direction parallel to the rotation shaft direction of the toner container 32. As illustrated in FIG. 17, one-side end of the movable claw 345c is positioned so as to be close to or to be in contact with an outer peripheral surface of a container front end side portion (portion to which the container front end cover 34 is attached) of the container body 33. Specifically, the outer peripheral surface of the container front end side portion of the container body 33 is provided with a protrusion 304t, and one-side end of the movable claw 345c is at a position where the movable claw 345c is in contact with the protrusion 304t when the protrusion 304t passes through a portion facing the one-side end of the movable claw 345c. On the other hand, the other-side end of the movable claw 345c can abut on the claw receiving wall 304u of the container front end cover 34.

In the present embodiment, when the container body 33 of the toner container 32 rotates in the reverse direction B, as illustrated in FIG. 16B, the protrusion 304t on the outer peripheral surface of the container front end side of the container body 33 passes through the portion facing the one-side end of the movable claw 345c. At this time, the contact with the protrusion 304t causes the one-side end of the movable claw 345c to be pushed in the reverse direction B, and the movable claw 345c receives a force in a direction rotating around the rotation shaft 345d clockwise in the drawing.

On the other hand, when the one-side end of the movable claw 345c is pushed in the reverse direction B of the container body 33, the other-side end of the movable claw 345c abuts on the claw receiving wall 304u of the container front end cover 34. As a result, the force of the one-side end of the movable claw 345c pushed in the reverse direction B by the protrusion 304t causes the movable claw 345c to rotate clockwise in the drawing with the abutment position between the other-side end and the claw receiving wall 304u as a fulcrum. As a result, a force acts on the rotation shaft 345d of the movable claw 345c in a direction (direction of arrow C in the drawing) in which the tag holder 345a opposes the biasing force of the spring 345b along the displaceable direction of the tag holder 345a. Therefore, as illustrated in FIG. 17, the tag holder 345a provided with the rotation shaft 345d is displaced in the direction C against the biasing force of the spring 345b.

Thereafter, when the protrusion 304t of the container body 33 passes through the portion facing the one-side end of the movable claw 345c, the biasing force of the spring 345b causes the tag holder 345a to be displaced in the direction opposite to the arrow C in the drawing, and returned to the position abutting on the holder receiving wall 304s of the container front end cover 34.

As described above, when the tag holder 345a is displaced by the rotation of the container body 33 of the toner container 32 in the reverse direction B opposite to the normal direction A, the relative position between the ground terminal 703 and the metal pad 710 of the ID tag 700 on the tag holder 345a and the grounding body-side terminal 802 and the communication body-side terminal 804 of the connector 800 is changed. Specifically, the grounding body-side terminal 802 and the communication body-side terminal 804 of the connector 800 relatively move so as to slide on the electrode surfaces of the ground terminal 703 and the metal pad 710 of the ID tag 700. Such a change in the relative position (relative movement) removes toner adhering between the ground terminal 703 and the metal pad 710 of the ID tag 700 and the grounding body-side terminal 802 and the communication body-side terminal 804 of the connector 800, thereby eliminating a contact failure.

In addition, in the present embodiment, in the case where the container body 33 of the toner container 32 rotates in the normal direction A, when the protrusion 304t of the container body 33 passes through the portion facing the one-side end of the movable claw 345c, the protrusion 304t presses the one-side end of the movable claw 345c in the rotation direction (normal direction) A of the container body 33. In this case, the other-side end of the movable claw 345c does not abut on the claw receiving wall 304u of the container front end cover 34, and the movable claw 345c rotates around the rotation shaft 345d counterclockwise in the drawing. As a result, a force for displacing the tag holder 345a does not act on the rotation shaft 345d of the movable claw 345c, and the tag holder 345a is kept abutting on the holder receiving wall 304s of the container front end cover 34 as illustrated in FIG. 16A.

Therefore, according to the present embodiment, during the toner conveyance operation in which the container body 33 of the toner container 32 rotates in the normal direction A, the ground terminal 703 and the metal pad 710 of the ID tag 700 do not relatively move with respect to the grounding body-side terminal 802 and the communication body-side terminal 804 of the connector 800. Therefore, the contact is hardly worn and a problem such as a shortened life can be reduced.

The present embodiment has a configuration in which the movable claw 345c is rotatable about the rotation shaft 345d on the tag holder 345a, but embodiments of the present disclosure is not limited to the configuration. For example, the movable claw 345c may be formed of a flexible member, and the movable claw 345c may be secured to the tag holder 345a.

In this case, when the container body 33 rotates in the normal direction A, the protrusion 304t of the container body 33 comes into contact with the one-side end of the movable claw 345c, whereby the movable claw 345c is pushed in the rotation direction (normal direction) A of the container body 33. However, since the tag holder 345a to which the movable claw 345c is secured abuts on the holder receiving wall 304s, a state of being abutted on the holder receiving wall 304s of the container front end cover 34 is maintained. Then, the movable claw 345c pushed in the rotation direction (normal direction) A of the container body 33 is deformed, and the protrusion 304t of the container body 33 passes through a portion facing the one-side end of the movable claw 345c.

On the other hand, when the container body 33 rotates in the reverse direction B, the protrusion 304t of the container body 33 comes into contact with the one-side end of the movable claw 345c, the protrusion 304t is caught by the movable claw 345c, and the movable claw 345c is pushed in the reverse direction B. In this case, the tag holder 345a to which the movable claw 345c is secured is pushed in the reverse direction B integrally with the movable claw 345c, and is displaced in the direction against the biasing force of the spring 345b. Thereafter, when the protrusion 304t of the container body 33 further moves in the reverse direction B, the deformation of the movable claw 345c releases the hook between the protrusion 304t of the container body 33 and the movable claw 345c. As a result, the protrusion 304t of the container body 33 passes through a portion facing the one-side end of the movable claw 345c, and the biasing force of the spring 345b causes the tag holder 345a to be returned to a position abutting on the holder receiving wall 304s of the container front end cover 34.

In the present embodiment, a contact direction in which the grounding body-side terminal 802 and the communication body-side terminal 804 of the connector 800 are in contact with the ground terminal 703 and the metal pad 710 of the ID tag 700 is not in particular limited. Therefore, the contact direction may be a direction oblique to the vertical direction or the horizontal direction as illustrated in FIG. 13, may be a direction along the vertical direction as illustrated in the schematic diagram of FIGS. 16A and 16B, or may be a direction along the horizontal direction as illustrated in the schematic diagram of FIG. 18. However, as illustrated in FIG. 13, when the grounding body-side terminal 802 and the communication body-side terminal 804 of the connector 800 are in contact with the ground terminal 703 and the metal pad 710 of the ID tag 700 from a direction within a range of ±45° with respect to the horizontal direction, the toner adhering between the connector 800 and the ID tag 700 is likely to fall downward due to the action of gravity at the time of the relative movement described above, and the toner is easily removed, so that the contact failure is easily eliminated.

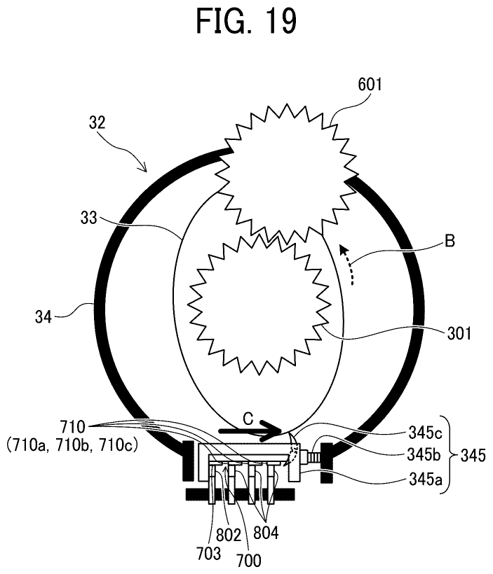

The present embodiment has a configuration in which, when the protrusion 304t on the outer peripheral surface of the container front end side portion of the container body 33 comes into contact with the movable claw 345c, the movable claw 345c is operated, but embodiments of the present disclosure is not limited to the configuration. For example, as illustrated in FIG. 19, the container front end side portion of the container body 33 may be configured such that the outer shape when viewed from the axial direction of the toner container 32 is an elliptical shape. In this case, the outer peripheral portion on the long axis side of the container body 33 functions similarly to the protrusion 304t described above.

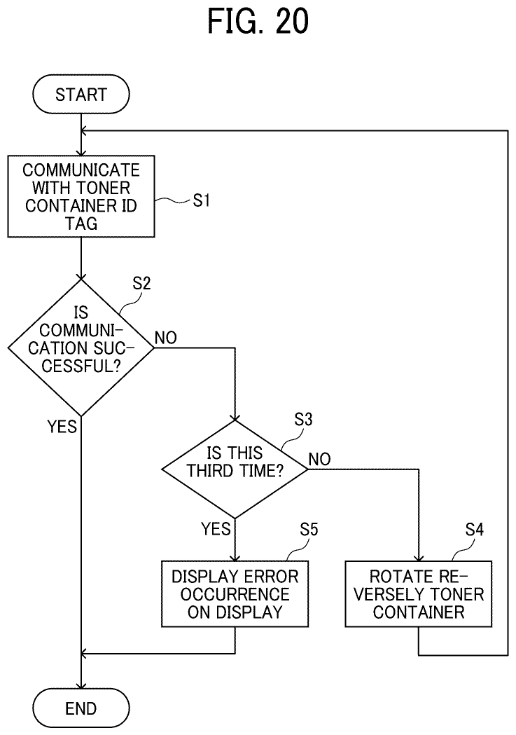

FIG. 20 is a flowchart illustrating an example of a contact recovery operation between the ground terminal 703 and the metal pad 710 of the ID tag 700 and the grounding body-side terminal 802 and the communication body-side terminal 804 of the connector 800 in the present embodiment.

In the present embodiment, under the control of the controller 90, the connector 800 communicates with the ID tag 700 of the toner container 32 at a predetermined communication timing (S1). At this time, when the communication fails (No in S2 and No in S3), the controller 90, which is an example of control circuitry, controls the container rotation driver 91 to rotationally drive the container body 33 of the toner container 32 in the reverse direction B opposite to the normal direction A (S4). As a result, as described above, the relative position between the ground terminal 703 and the metal pad 710 of the ID tag 700 on the toner container 32 side and the grounding body-side terminal 802 and the communication body-side terminal 804 of the connector 800 on the image forming apparatus body side is changed, and the contact is recovered.

Thereafter, the controller 90 communicates with the ID tag 700 of the toner container 32 by the connector 800 (S1), and when the communication is successful (Yes in S2), the contact recovery operation is terminated. On the other hand, when the communication has failed continuously 3 times (Yes in S3), the controller 90 displays a notification of the occurrence of the communication error on the display unit of the copier 500 (S5).

The embodiments described above are just examples, and the various aspects of the present disclosure attain respective effects as follows.

### First Aspect

According to a first aspect, an image forming apparatus (for example, the copier 500) includes: a developer container (for example, the toner container 32) detachably attached to an image forming apparatus body (for example, the printer unit 100) and including a securing unit (for example, the container front end cover 34) secured to the image forming apparatus body and a rotator (for example, the container body 33) relatively rotatable with respect to the securing unit; an image forming device (for example, the printer unit 100) to form an image using a developer (for example, toner) that is discharged from a developer discharge port (for example, the nozzle receiving port 331) of the securing unit by rotation of the rotator in a normal direction; a container-side electrode unit (for example, the ground terminal 703 and the metal pad 710) provided with the securing unit; and a body-side electrode unit (for example, the grounding body-side terminal 802 and the communication body-side terminal 804) to contact the container-side electrode unit of the developer container attached to the image forming apparatus body; and a position changer (for example, the holding mechanism 345) to change a relative position between the container-side electrode unit and the body-side electrode unit of the developer container attached to the image forming apparatus body. The position changer changes the relative position with rotation of the rotator in a reverse direction (for example, the reverse direction B) opposite to the normal direction.

In an image forming apparatus of the related art, when a rotator of a developer container is rotated for the operation of discharging developer in the developer container from a developer discharge port of the developer container (developer conveying operation), the relative position between a container-side electrode unit and a body-side electrode unit is changed in conjunction with the operation of rotating the rotator. Therefore, the relative position between the container-side electrode unit and the body-side electrode unit is constantly changed during the developer conveying operation of the developer container. As a result, wear is likely to progress between the container-side electrode unit and the body-side electrode unit, and defects such as shortening of the life are likely to occur.

In the present aspect, the rotator of the developer container does not rotate in a normal direction, which is the rotation direction during the developer conveying operation, but in a reverse direction opposite to the normal direction, so that the relative position between the container-side electrode unit and the body-side electrode unit is changed. As a result, when the rotator is rotated in the reverse direction at a necessary timing other than during the developer conveying operation, the relative position between the container-side electrode unit and the body-side electrode unit is changed, and a contact failure between the container-side electrode unit and the body-side electrode unit due to, for example, adhesion of the developer can be eliminated. According to the present aspect, since it is not necessary to change the relative position between the container-side electrode unit and the body-side electrode unit at the time of rotation in the normal direction which is the rotation direction during the developer conveying operation, wear between the container-side electrode unit and the body-side electrode unit can be reduced.

### Second Aspect

According to a second aspect, in the image forming apparatus of the first aspect, the container-side electrode unit is displaceable with respect to the securing unit, and the position changer displaces the container-side electrode unit, with rotation of the rotator in the reverse direction, to change the relative position.

In the present aspect, since the configuration of displacing the container-side electrode unit provided in the developer container is adopted, the relative position between the container-side electrode unit and the body-side electrode unit can be changed even when a configuration of displacing the body-side electrode unit disposed on the image forming apparatus body side is not used. Therefore, since the existing configuration in which the body-side electrode unit is not displaced can be adopted as the configuration on the image forming apparatus body side, wear between the container-side electrode unit and the body-side electrode unit can be reduced when the present developer container is attached to the existing image forming apparatus.

### Third Aspect

According to a third aspect, in the image forming apparatus of the second aspect, the position changer includes an engaging part (for example, the protrusion 304t) that rotationally moves with rotation of the rotator, and an engaged part (for example, the movable claw 345c) provided with the securing unit to be positioned on a rotational movement path of the engaging part. The position changer displaces the container-side electrode unit in conjunction with a predetermined engagement state (for example, the protrusion 304t and the movable claw 345c contacts each other when the rotator rotates in the reverse direction B) between the engaging part and the engaged part. When the rotator rotates in the reverse direction, the engaging part enters the predetermined engagement state in passing through the engaged part, and when the rotator rotates in the normal direction, the engaging part passes through the engaged part without entering the predetermined engagement state.

According to this configuration, the position changer having a simple configuration can be implemented.

### Fourth Aspect

According to a fourth aspect, in the image forming apparatus of the third aspect, the engaged part includes a moving member (for example, movable claw 345c) to move in a first direction due to abutment of the engaging part when the rotator rotates in the reverse direction, and move in a second direction by abutment of the engaging part when the rotator rotates in the normal direction. The container-side electrode unit is displaced in conjunction with movement of the moving member in the first direction, and is not displaced even when the moving member moves in the second direction.

According to this configuration, the position changer having a simple configuration can be implemented.

### Fifth Aspect

According to a fifth aspect, in the image forming apparatus of any one of the first to fourth aspects, the body-side electrode unit contacts the container-side electrode unit from a direction within a range of ±45° with respect to a horizontal direction.

According to this configuration, when the relative position between the container-side electrode unit and the body-side electrode unit is changed, foreign matter such as developer adhering between the container-side electrode unit and the body-side electrode unit easily drops downward due to the action of gravity, and the foreign matter is easily removed.

### Sixth Aspect

According to a sixth aspect, the image forming apparatus of any one of the first to fifth aspects includes: a communicator (for example, the connector 800) to perform communication via the container-side electrode unit and the body-side electrode unit; and a controller (for example, the controller 90) to perform position change control to cause the position changer to change the relative position when a communication failure occurs in the communication performed by the communicator, and causes the communicator to perform the communication in which the communication failure has occurred, after the position change control is performed.

According to this configuration, when a communication failure via the container-side electrode unit and the body-side electrode unit occurs, it is possible to eliminate the communication failure and resume the communication without involving work of, for example, a user.

### Seventh Aspect

According to a seventh aspect, a developer container (for example, the toner container 32) detachably attachable to an image forming apparatus body (for example, the printer unit 100) includes: a securing unit (for example, the container front end cover 34) secured to the image forming apparatus body; and a rotator (for example, the container body 33) relatively rotatable with respect to the securing unit, the securing unit having a developer discharge port (for example, the nozzle receiving port 331) from which a developer (for example, toner) is discharged by rotation of the rotator in a normal direction (for example, the normal direction A); a container-side electrode unit (for example, the ground terminal 703 and the metal pad 710) provided with the securing unit, to contact a body-side electrode unit (for example, the grounding body-side terminal 802 and the communication body-side terminal 804) of the image forming apparatus body when the developer container is attached to the image forming apparatus body; and a position changer (for example, the holding mechanism 345) to change a relative position between the container-side electrode unit and the body-side electrode unit, when the rotator is rotated in a reverse direction B opposite to the normal direction.

According to the present aspect, a developer container is provided that can prevent a contact failure due to a change in a relative position between a container-side electrode unit and a body-side electrode unit while reducing wear between the container-side electrode unit and the body-side electrode unit.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus, comprising:
an image forming apparatus body;
a developer container detachably attached to the image forming apparatus body, the developer container including:
a securing unit secured to the image forming apparatus body;
a rotator relatively rotatable with respect to the securing unit; and
a container-side electrode unit provided with the securing unit;
an image forming device to form an image with a developer that is discharged from a developer discharge port of the securing unit by rotation of the rotator in a normal direction;
a body-side electrode unit to contact the container-side electrode unit of the developer container attached to the image forming apparatus body; and
a position change structure to change a relative position between the container-side electrode unit and the body-side electrode unit of the developer container attached to the image forming apparatus body, with rotation of the rotator in a reverse direction opposite to the normal direction.

2. The image forming apparatus according to claim 1,
wherein the container-side electrode unit is displaceable with respect to the securing unit, and
the position change structure displaces the container-side electrode unit, with rotation of the rotator in the reverse direction, to change the relative position.

3. The image forming apparatus according to claim 2,
wherein the position change structure includes:
an engaging part to rotationally move with rotation of the rotator; and
an engaged part provided with the securing unit, to be positioned on a rotational movement path of the engaging part, and
the position change structure displaces the container-side electrode unit in conjunction with a predetermined engagement state between the engaging part and the engaged part, and
when the rotator rotates in the reverse direction, the engaging part enters the predetermined engagement state in passing through the engaged part, and when the rotator rotates in the normal direction, the engaging part passes through the engaged part without entering the predetermined engagement state.

4. The image forming apparatus according to claim 3,
wherein the engaged part includes a moving member to move in a first direction by abutment of the engaging part when the rotator rotates in the reverse direction, and move in a second direction by abutment of the engaging part when the rotator rotates in the normal direction, and
the container-side electrode unit is displaced in conjunction with movement of the moving member in the first direction, and is not displaced when the moving member moves in the second direction.

5. The image forming apparatus according to claim 1,
wherein the body-side electrode unit contacts the container-side electrode unit from a direction within a range of ±45° with respect to a horizontal direction.

6. The image forming apparatus according to claim 1, further comprising:
a communicator to perform communication via the container-side electrode unit and the body-side electrode unit; and
control circuitry configured to:
perform position change control to cause the position change structure to change the relative position when a communication failure occurs in the communication performed by the communicator; and
cause the communicator to perform the communication in which the communication failure has occurred, after the position change control is performed.

7. A developer container detachably attachable to an image forming apparatus body, the developer container comprising:
a securing unit secured to the image forming apparatus body;
a rotator relatively rotatable with respect to the securing unit, the securing unit having a developer discharge port from which a developer is discharged by rotation of the rotator in a normal direction;
a container-side electrode unit provided with the securing unit, to contact a body-side electrode unit of the image forming apparatus body when the developer container is attached to the image forming apparatus body; and
a position change structure to change a relative position between the container-side electrode unit and the body-side electrode unit, when the rotator is rotated in a reverse direction opposite to the normal direction.
